(19) United States
(12) Patent Application Publication
(10) Pub. No.: US 2004/0112375 A1
(43) Pub. Date: Jun. 17, 2004

(54) Predicting outcome of hyperbaric oxygen therapy treatment with nitric oxide bioavailability

(76) Inventor: Joseph V. Boykin JR., Chester, VA (US)

Correspondence Address: BANNER & WITCOFF, 1001 G STREET N W, SUITE 1100, WASHINGTON, DC, 20001, US

(21) Appl. No.: 10/716,657

(22) Filed: Nov. 20, 2003

Related U.S. Application Data
(60) Provisional application No. 60/427,573, filed on Nov. 20, 2002.
(60) Provisional application No. 60/492,732, filed on Aug. 6, 2003.

(51) Int. Cl. A62B 9/00

(52) U.S. Cl. 128/200.24

(57) ABSTRACT

Methods and kits are provided for determining whether a patient will respond favorably to hyperbaric oxygen therapy treatment. The method comprises the step of comparing nitric oxide production, a nitric oxide-related product level, and/or the nitric oxide bioactivity index in a specimen from a patient with a threshold value. If nitric oxide production, nitric oxide-related product level, and/or the nitric oxide bioactivity index (defined as “the level of a nitric oxide-related product to the level of an oxidant stress-related product”) is above the threshold value then the patient will respond favorably to hyperbaric oxygen therapy treatment. If nitric oxide production, nitric oxide-related product level, and/or the nitric oxide bioactivity index is approximately at or below the threshold value then the patient may not respond favorably to hyperbaric oxygen therapy treatment.

This application claims the benefit of and incorporates by reference co-pending provisional application Serial No. 60/427,573 filed Nov. 20, 2002 and Serial No. 60/492,732 filed Aug. 6, 2003. These applications are incorporated herein by reference in their entireties.

### FIELD OF THE INVENTION

The invention is related to hyperbaric oxygen therapy. In particular it is related to assays for nitric oxide production, nitrate and/or nitrite, and the bioactivity of nitric oxide and their use in predicting and improving clinical outcomes for patients undergoing hyperbaric oxygen therapy treatment.

### BACKGROUND OF THE INVENTION

Hyperbaric oxygen therapy treatment is used on patients with chronic wounds and has been clinically demonstrated to accelerate healing of chronic wounds (Boykin, Wounds 8, 183-198, 1996). However, not all patients with chronic wounds will respond and heal when treated with hyperbaric oxygen therapy.

There remains a need in the art for methods of determining whether a patient will respond to hyperbaric oxygen therapy treatment.

### BRIEF SUMMARY OF THE INVENTION

In one embodiment of the invention a method for determining whether a patient will respond favorably to hyperbaric oxygen therapy treatment is provided. The method comprises the steps of comparing nitric oxide production level in a patient with a threshold value and determining if the patient will respond favorably to hyperbaric oxygen therapy treatment. If the nitric oxide production level is above the threshold value then the patient will respond favorably to hyperbaric oxygen therapy treatment. If the nitric oxide production is approximately at or below the threshold value then the patient may not respond favorably to hyperbaric oxygen therapy treatment.

In another embodiment of the invention a method for determining whether a patient will respond to hyperbaric oxygen therapy treatment is provided. The method comprises the steps of comparing the level of a nitric oxide-related product in a specimen from a patient with a threshold value and determining if the patient will respond favorably to hyperbaric oxygen therapy treatment. If the nitric oxide-related product level is above the threshold value then the patient will respond favorably to hyperbaric oxygen therapy treatment. If the nitric oxide-related product level is approximately at or below the threshold value then the patient may not respond favorably to hyperbaric oxygen treatment.

In still another embodiment of the invention a method for determining whether a patient will respond to hyperbaric oxygen therapy treatment is provided. The method comprises the steps of comparing the nitric oxide bioactivity index value in a specimen from a patient with a threshold value and determining if the patient will respond favorably to hyperbaric oxygen therapy treatment. The nitric oxide bioactivity index is defined as the level of a nitric oxide-related product in a specimen from the patient divided by the level of an oxidant stress related product from the same or similar specimen from the patient. If the nitric oxide bioactivity index is above the threshold value then the patient will respond favorably to hyperbaric oxygen therapy treatment. If the nitric oxide bioactivity index value is approximately at or below the threshold value then the patient may not respond favorably to hyperbaric oxygen therapy treatment.

In yet another embodiment of the invention a method for determining whether a patient will respond to hyperbaric oxygen therapy treatment is provided. The method comprises the steps of comparing the nitric oxide bioactivity index value in a specimen from a patient with a threshold value and determining if the patient will respond favorably to hyperbaric oxygen therapy treatment. The nitric oxide bioactivity index is defined as the level of an oxidant stress related product in a specimen from the patient divided by the level of a nitric oxide-related product from the same or similar specimen from the patient. If the nitric oxide bioactivity index is below the threshold value then the patient will respond favorably to hyperbaric oxygen therapy treatment. If the nitric oxide bioactivity index value is approximately at or above the threshold value then the patient may not respond favorably to hyperbaric oxygen therapy treatment.

In still yet another embodiment of the invention a kit for determining whether a patient will respond favorably to hyperbaric oxygen therapy treatment is provided. The kit comprises either (1) one or more reagents for determining the level of a nitric oxide-related product in a specimen from the patient, (2) one or more reagents for determining the level of a nitric oxide-related product in a specimen from the patient, and (3) one or more reagents for determining the level of an oxidant stress related product in the specimen and one or more reagents for determining the level of a nitric oxide-related product in the specimen from the patient.

### BRIEF DESCRIPTION OF THE DRAWINGS

FIG. 1 presents a schematic representation of the role of nitric oxide (NO) in wound repair regulation and indicates where hyperbaric oxygen therapy treatment exerts an effect. Wound NO-mediated “cellular signaling” appears to enhance the inflammatory mediation of repair, wound oxygen availability, and wound matrix remodeling and maturation. Hyperbaric oxygen therapy treatment increases the oxygen availability to the wound.

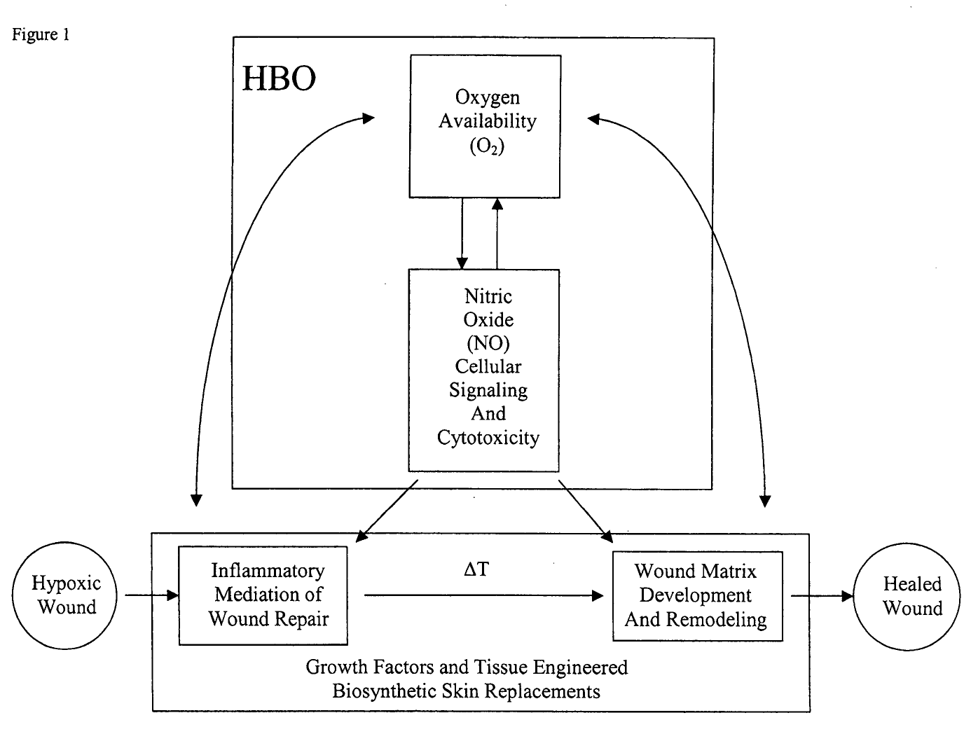

FIG. 2 shows urine nitrate excretion of a patient prior to hyperbaric oxygen therapy treatment (PreTx), at weeks 10 and 20 during treatment (#10 and #20, respectively), and 1 week and 4 weeks post-treatment (1 wk and 4 wk, respectively). Also shown is urine nitrate excretion of eight healthy, non-diabetic adults (control).

FIG. 3 shows plasma nitrate levels of a patient prior to hyperbaric oxygen therapy treatment (PreTx), at weeks 10 and 20 during treatment (#10 and #20, respectively), and 1 week and 4 weeks post-treatment (1 wk and 4 wk, respectively). Also shown are plasma nitrate levels of eight healthy, non-diabetic adults (control).

FIG. 4 shows wound fluid nitrate levels of a patient prior to hyperbaric oxygen therapy treatment (PreTx), at weeks 10 and 20 during treatment (#10 and #20, respectively), and 1 week and 4 weeks post-treatment (1 wk and 4 wk, respectively).

FIG. 5 shows wound closure and plasma nitrate levels prior to hyperbaric oxygen therapy treatment, during treatment, and post-treatment.

FIG. 6 shows plasma nitrate levels of three patients prior to hyperbaric oxygen therapy treatment (PreTx), at weeks 10 and 20 during treatment (#10 and #20, respectively), and at 1 and 4 weeks post-treatment 1 wk and 4 wk, respectively).

### DETAILED DESCRIPTION OF THE INVENTION

The invention provides a method to determine which patients will respond favorably to hyperbaric oxygen therapy treatment. The method comprises the steps of comparing nitric oxide production, a nitric oxide-related product level, and/or the nitric oxide bioactivity index (NOBI) in a specimen from a patient with a threshold value and determining if the patient will respond favorably to hyperbaric oxygen therapy treatment. If the level of nitric oxide production, nitrate and/or nitrite levels, and/or nitric oxide bioactivity index (defined as a ratio of a nitric oxide-related product to an oxidant stress related product) is above a threshold value then the patient will respond favorably to treatment with hyperbaric oxygen. If the level of nitric oxide production, nitric oxide-related product, and/or nitric oxide bioactivity index (defined as a ratio of a nitric oxide-related product to an oxidant stress related product) is approximately at or below a threshold value then the patient may not respond favorably to treatment with hyperbaric oxygen. The specimen can be, for example, urine, blood, or wound fluid. Responding favorably to hyperbaric oxygen therapy treatment means that a wound on the patient heals and not responding to hyperbaric oxygen therapy means that the wound on the patient does not heal.

Patient Selection for Hyperbaric Oxygen Therapy Treatment

The nitric oxide production level, nitric oxide-related product level, and/or NOBI values can be predictive of which patients may respond favorably to hyperbaric oxygen therapy treatment and which patients will not respond to hyperbaric oxygen therapy treatment. Patients that have a nitric oxide production level, nitric oxide-related product level, and/or a NOBI (defined as a ratio of a nitric oxide-related product to an oxidant stress related product) value above a threshold value will respond favorably to hyperbaric oxygen therapy treatment. Those patients that have a nitric oxide production level, nitric oxide-related product levels, and/or a NOBI (defined as a ratio of a nitric oxide-related product to an oxidant stress related product) value approximately at or below the threshold value may not respond favorably to hyperbaric oxygen therapy treatment.

Patients with a nitric oxide production, nitric oxide-related product, and/or a NOBI (defined as a ratio of a nitric oxide-related product to an oxidant stress related product) value at or below the threshold value are unlikely to respond to hyperbaric oxygen therapy treatment. If hyperbaric oxygen therapy treatment is administered to these patients, the patient may or may not respond favorably to the hyperbaric oxygen therapy treatment. The patients that may respond to treatment usually show an early indication in the treatment that a response is likely. Such early indications include, but are not limited to, an elevation in nitric oxide production, an elevation in nitric oxide-related product levels, and/or an elevation in NOBI (defined as a ratio of a nitric oxide-related product to an oxidant stress related product). The early indications usually occur within the first 10-14 (i.e., 10, 11, 12, 13, or

14) days of treatment and/or the first 5-10 (i.e., 5, 6, 7, 8, 9, or 10) treatments. The early indication is preferably a minimum of a 50% or more (i.e., 50, 60, 70, 75, 80, 90, 95, 100, 105, 110, 120, 150% or more) increase in plasma nitrate levels (a nitric oxide-related product). Patients not demonstrating the early indications are unlikely to respond to the hyperbaric oxygen therapy treatment. Such patients should be treated in such a manner as to increase nitric oxide production and/or decrease oxidant stress prior to retreating with hyperbaric oxygen therapy. Methods for increasing nitric oxide production and/or decreasing oxidant stress are described below.

Hyperbaric Oxygen Therapy

Hyperbaric oxygenation is achieved when a patient breathes 100% oxygen in an environment of elevated atmospheric pressure (Boykin, Adv Skin Wound Care, 13:169-174, 2000; Boykin, Wounds 8, 183-198, 1996). Atmospheric pressure elevations range from about 2 absolute atmospheres of pressure to about 3 absolute atmospheres of pressure. Preferably atmospheric pressure elevations range from about 2 absolute atmospheres of pressure to about 2.4 absolute atmospheres of pressure. Treatment time ranges from about 10 minutes to about 240 minutes (i.e., 10, 15, 30, 60, 90, 120, 150, 180, 210, or 240 minutes). The patient can be treated once or multiple times (i.e., 2, 5, 10, 15, 20, 25, or 30 times) in the hyperbaric chamber. Treatment can be administered daily, every other day, every third day, or weekly, or multiple treatments can be administered on the same day (i.e., 2 treatments per day). Preferably, treatment is administered every day. Treatment time is preferably 90 minutes. Preferably the patient is treated 10 or 20 times.

Nitric Oxide Production

Nitric oxide is generated by three isoforms of nitric oxide synthase (NOS), which metabolize L-arginine and molecular oxygen to citruline and nitric oxide. Two of the three isoforms are constitutive enzyme systems (cNOS) that are described in neuronal cells (NNOS) and in endothelial cells (eNOS) (D Bruch-Gerharz, T Ruzicka, V Kolb-Bachofen. J Invest Dermatol. 110, 1 (1998)). With these isoforms, increased levels of intracellular calcium activate the enzymes via calmodulin. The calcium-dependent cNOS systems produce low (picomolar) concentrations of NO. The third system is the inducible isoform (iNOS) which is calcium independent. The expression of iNOS is induced by tissue-specific stimuli such as inflammatory cytokines or bacterial lipopolysaccharide (LPS). The inducible isoform releases NO in much higher (nanomolar) concentrations than cNOS and has potent cytotoxic effects. Nitric oxide production can be predictive for which patients will respond favorably to hyperbaric oxygen therapy treatment. Patients who will respond favorably to hyperbaric oxygen therapy treatment may have higher nitric oxide production than patients who will not respond favorably to the hyperbaric oxygen therapy treatment. Nitric oxide production can be determined, for example, using electron paramagnetic resonance (EPR). Such methods are described, for example, in Lakshmi et al., Curr Opin Struct Biol 11:523-31 (2001), Kuppusamy et al., Magn Reson Med 45:700-7 (2001), James et al., Nitric Oxide 3:292-301 (1999), James et al., Adv Exp Med Biol 454:181-7 (1998), Xia et al., Proc Natl Acad Sci U.S.A. 94:12705-10 (1997), Zweier et al., JMagn Reson B 109:259-63 (1995), Zweier et al, JBiol Chem 270:304-7 (1995), and Archer, FASEB J 7:349-60 (1993).

Nitric Oxide-Related Products

“Nitric oxide-related products” are molecular species related to nitric oxide synthesis or breakdown. Examples of nitric oxide-related products include, but are not limited to, nitrate, nitrite, L-citruline, L-dimethylarginine, ascorbyl radical, albumin-thinyl radical, and 3-nitrotyrosine. Nitric oxide-related products can be quantified in blood, urine, tissue, or other samples from a patient. The preferred nitric oxide-related product is nitrate, more preferably nitrate quantified from blood (i.e., plasma nitrate).

Plasma levels of L-citrulline, which is a product of the reaction that produces nitric oxide, or cGMP, which is produced as a result of nitric oxide activation of guanylate cyclase, can be determined as a reflection of systemic nitric oxide synthesis (NOS) in a patient. (Kiechle and Malinski, Ann. Clin. Lab. Sci. 26, 501 (1996)). Similarly, L-dimethylarginine, another product of NOS, can be detected by HPLC of human serum and used as a highly specific index of systemic NOS activity. (Meyer et al., Anal. Biochem. 247, 11 (1997)). Nitric oxide can also break down by reacting with superoxide anion in human plasma to produce peroxynitrite, which in turn can produce a variety of radicals such as ascorbyl radical and albumin-thinyl radical that can be detected using electron paramagnetic resonance (EPR) spectroscopy. (Vasquez-Vivar et al., Biochem. J 314, 869 (1996)). Another product of peroxynitrite is 3-nitrotyrosine, which can be detected in human plasma or other fluids by gas chromatography in tandem with mass spectrometry (Schwedhelm et al., Anal. Biochem. 276, 195 (1999)), reversed-phase HPLC (Ohshima et al., Nitric Oxide 3, 132 (1999)), or an ELISA method using anti-nitrotyrosine antibodies (ter Steege et al., Free Radic. Biol. Med. 25, 953 (1998)). Unlike nitrate or nitrite, most of these products are not subject to interference by dietary intake. Furthermore, in situ detection of nitric oxide itself is possible with the aid of biosensors that quantify nitric oxide levels and changes in nitric oxide levels in response to stimuli. For example, the heme domain of soluble guanylate cyclase, a natural receptor for nitric oxide, can be labeled with a fluorescent reporter dye, and changes in fluorescence intensity can be determined through an optical fiber and calibrated to reveal nitric oxide levels at any desired location in the body, for example at or near a wound site (Barker et al., Anal. Chem. 71, 2071 (1999)). Given the rapid decomposition of nitric oxide in biological fluids, direct detection of nitric oxide should be performed in situ rather than some time following collection of a specimen.

Nitrate and Nitrite Levels

Nitric oxide has a half-life of about five seconds in biological tissues. A major metabolic pathway for nitric oxide is to nitrate and nitrite, which are stable metabolites within tissue, plasma, and urine (S Moncada, A Higgs, N Eng J Med 329, 2002 (1993)). Tracer studies in humans have demonstrated that perhaps 50% of the total body nitrate/nitrite originates from the substrate for NO synthesis, L-arginine (PM Rhodes, AM Leone, PL Francis, AD Struthers, S Moncada, Biomed Biophys Res. Commun. 209, 590 (1995); L. Castillo et al., Proc Natl Acad Sci USA 90, 193 (1993). Although nitrate and nitrite are not measures of biologically active NO, plasma and urine samples obtained from subjects after a suitable period of fasting, and optionally after administration of a controlled diet (low nitrate/low arginine), allow the use of nitrate and nitrite as an index of NO activity (C Baylis, P Vallance, Curr Opin Nephrol Hypertens 7, 59 (1998)). Nitrate and nitrite levels in a sample from a patient can be predictive for which patients will respond favorably to hyperbaric oxygen therapy treatment. Patients who will respond favorably to hyperbaric oxygen therapy treatment will have higher nitrate and nitrite levels than patients who will not respond favorably to the hyperbaric oxygen therapy treatment. Use of other nitric oxide-related products is also contemplated. Such products are described below.

Determination of Nitrate and Nitrite Levels

The level of nitrate or nitrite in the specimen can be quantified by any method known in the art which provides adequate sensitivity and reproducibility. For example, the Griess reaction is a spectrophotometric assay for nitrate which can provide sensitive determination of nitrate and nitrite in biological fluid samples (M Marzinzig et al., Nitric Oxide 1, 177 (1997)). If the Griess reaction or another nitrite assay is performed both with and without reduction of nitrate to nitrite, then nitrate values can be obtained as the difference between the nitrite values obtained for the reduced sample and the non-reduced sample. The Griess assay can be made more sensitive if a fluorescent product is obtained, e.g., by reacting nitrite with 2,3-diaminonaphalene (TP Misko et al., Anal. Biochem. 214, 11 (1993)). Highly sensitive assays are also available which first reduce nitrite and nitrate (RS Braman and SA Hendrix, Anal. Chem. 61, 2715 (1989)) or any NO-related compound (M Sonoda et al., Anal. Biochem. 247, 417 (1997) to NO for detection with specific chemiluminesence reagents. A variety of protocols have also been described for detecting and quantifying nitrite and nitrate levels in biological fluids by ion chromatography (e.g., SA Everett et al., J. Chromatogr. 706, 437 (1995); JM Monaghan et al., J. Chromatogr. 770, 143 (1997)), high-performance liquid chromatography (e.g., M Kelm et al., Cardiovasc. Res. 41, 765 (1999)), and capillary electrophoresis (MA Friedberg et al., J. Chromatogr. 781, 491 (1997)).

Although nitrate and nitrite are not measures of biologically active nitric oxide, plasma and urine samples obtained from patients after a suitable period of fasting, and optionally after administration of a controlled diet (low nitrate/low arginine), allow the use of nitrate and nitrite as an index of nitric oxide activity (Baylis and Vallance, Curr Opin Nephrol Hypertens 7, 59 (1998)).

The “level” of nitrate, nitrite, or other NO-related product usually refers to the concentration (in moles per liter, micromoles per liter, or other suitable units) of nitrate or nitrite in the specimen, or in the fluid portion of the specimen. However, other units of measure can also be used to express the level of nitrate or nitrite. For example, an absolute amount (in micrograms, milligrams, nanomoles, moles, or other suitable units) can be used, particularly if the amount refers back to a constant amount (e.g., grams, kilograms, milliliters, liters, or other suitable units) of the specimens under consideration. A number of commercially available kits can be used.

The specimen can be processed prior to determination of nitrate or nitrite as required by the quantification method, or in order to improve the results, or for the convenience of the investigator. For example, processing can involve centrifuging, filtering, or homogenizing the sample. If the sample is whole blood, the blood can be centrifuged to remove cells and the nitrate or nitrite assay performed on the plasma or serum fraction. If the sample is tissue, the tissue can be dispersed or homogenized by any method known in the art prior to determination of nitrate or nitrite. It may be preferable to remove cells and other debris by centrifugation or another method and to determine the nitrate or nitrite level using only the fluid portion of the sample, or the extracellular fluid fraction of the sample. The sample can also be preserved for later determination, for example by freezing of urine or plasma samples. When appropriate, additives may be introduced into the specimen to preserve or improve its characteristics for use in the nitrate or nitrite assay.

The threshold value of nitrate, nitrite, or other NO-related product can be determined by comparing patients with normal and poor wound healing ability using the method of detection described above. For example, by comparing the urinary nitrate levels of a group of non-wound healing patients with a group of wound healing patients, preferably following the administration of a low nitrate diet and after a fasting period, the nitrate levels of the two groups can be compared. The threshold value can be selected from the data obtained. For example, the threshold can be chosen as a value slightly higher than the mean of the urinary nitrate level of the non-wound healing group; the threshold value should be chosen such that the urinary nitrate levels of at least 70%, 80%, 90%, 95%, 98%, or 99% of the non-wound healing diabetics tested would fall at or below the threshold. For human patients, the threshold value for nitrate in urine is between 15 and 50 micromolar. Preferably, the threshold value for nitrate in human urine is between 20 and 45 micromolar, or between 25 and 40 micromolar. More preferably, the threshold value for nitrate in human urine is 20, 25, 28, 30, 32, 35, 37, or 40 micromolar. For human patients, the threshold value for nitrate in plasma is between 2 and 20 micromolar. Preferably, the threshold value for nitrate in human plasma is between 3 and 17 micromolar, or between 4 and 16 micromolar. More preferably, the threshold value for nitrate in human plasma is 2, 4, 6, 8, 10, 12, 14, 16, 18, or 20 micromolar. When selecting a threshold value of nitrate, nitrite, or other NO-related product for use with a given type of specimen, for example human urine or plasma, it should be noted that the use of different assays or methods of standardization could shift the numerical ranges from those provided here.

Nitric Oxide Bioactivity

A balance between nitric oxide synthesis and nitric oxide degradation determines the bioactivity of nitric oxide. Nitric oxide bioactivity is directly proportional to nitric oxide production and inversely proportional to the production of reactive oxygen species. Examples of reactive oxygen species include, but are not limited to, free radicals. Free radical generation results in nitric oxide scavenging and endothelial cell lipid peroxidation, and is a predominant factor responsible for the creation of oxidant stress, lipid peroxidation, and nitric oxide degradation.

Nitric Oxide Bioactivity Index

Nitric oxide bioactivity index (NOBI) is defined in U.S. utility application Ser. No. 10/290,496 (attorney docket number 4629.00015) filed Nov. 8, 2002, and provisional applications Serial No. 60/333,474 filed Nov. 28, 2001, Serial No. 60/349,348 filed Jan. 22, 2002, and Serial No. 60/370,246 filed Apr. 8, 2002. Nitric oxide bioactivity index is a ratio of the level of a nitric oxide-related product (discussed above) in a specimen from a patient to the level of an oxidant stress-related product (discussed below) in the same or similar specimen from the same patient, or its reciprocal (i.e., the level of an oxidant stress related product in a specimen to the level of a nitric oxide-related product in the same or similar specimen). NOBI values, when presented as the level of a nitric oxide-related product to the level of an oxidant stress-related product, will be numerically decreased in patients who may not respond favorably to hyperbaric oxygen therapy treatment. NOBI values, for patients who may not respond favorably to hyperbaric oxygen therapy treatment, will be increased when the reciprocal is used, i.e., the level of an oxidant stress-related product to the level of a nitric oxide-related product. NOBI values, when presented as the level of a nitric oxide-related product to the level of an oxidant stress-related product, will be numerically increased in patients who will respond favorably to hyperbaric oxygen therapy treatment. NOBI values, for patients who will respond favorably to hyperbaric oxygen therapy treatment, will be decreased when the reciprocal is used, i.e., the level of an oxidant stress-related product to the level of a nitric oxide-related product.

Threshold Value for NOBI

Assuming NOBI is calculated as the level of a nitric oxide-related product divided by the level of an oxidant stress-related product, then the threshold chosen will define the lower limit of the normal range of NOBI values. The threshold value should be chosen such that the NOBI of at least 70%, 80%, 90%, 95%, 98%, or 99% or more of the patients who do not respond to hyperbaric oxygen therapy treatment would fall at or below the threshold. Alternatively, the threshold can be selected as a value below the mean NOBI for the healthy control patients. For example, the threshold can be chosen as the mean of the control group minus an appropriate statistical measure, such as the standard error of the mean for the control group, a desired multiple (e.g., one, two, three, or more) of the standard deviation for the control group data, or a specified confidence interval (e.g., 80%, 85%, 90%, 95%, 98%, or 99% confidence interval) for the control group data.

For human patients, the threshold value for normal NOBI is between 10 and 40 micromoles of plasma nitrate per nanomole of plasma isoprostane. Preferably, the threshold value for normal human NOBI is between 20 and 30 or between 23 and 27 micromoles plasma nitrate per nanomole plasma isoprostane. More preferably, the threshold value for normal human NOBI is about 20, 23, 25, 28, 30, 32, 35, 37, or 40 micromoles plasma nitrate per nanomole plasma isoprostane. When selecting a threshold value of NOBI for use with a given type of specimen, for example human urine or plasma, it should be noted that the use of different nitric oxide-related products, different oxidant stress-related products, different detection assays, different units, or different methods of standardization could alter the specified numerical ranges.

If NOBI is calculated as the level of an oxidant stress-related product divided by the level of a nitric oxide-related product, i.e., the reciprocal of the calculation described above, then the threshold chosen will define the upper (not lower) limit of the normal range of NOBI values, and all numerical NOBI values stated earlier in this paragraph should be substituted with their reciprocal values.

Oxidant Stress-Related Products

A variety of molecular species can be determined as “oxidant stress-related products,” including, but not limited to, isoprostanes, malondialdehyde, conjugated dienes, thiobarbituric acid reactive substances, 4-hydroxynonenal, oxidized low density lipoprotein, serum lipid peroxide, and advanced glycation end products (AGEs). Oxidant stress-related products are formed by the reaction of superoxide, peroxynitrite, and other reactive oxygen species with membrane lipids (i.e., lipid peroxidation).

Isoprostanes

Isoprostanes (e.g., 8-epi-prostaglandin F₂ₐₗₚₕₐ) are preferred oxidant stress-related products. Isoprostanes are chemically stable products that result from the non-enzymatic reaction of arachidonic acid with oxygen radicals. The F₂ isoprostanes are a sensitive, direct marker of in vivo cellular oxidative damage caused by free radicals (i.e., a marker for lipid peroxidation). F₂ isoprostanes are also a marker for reactive oxygen species, which promote the degradation of nitric oxide and thereby reduce its bioactivity. F₂ isoprostanes are stable eicosanoids which are generated in conditions of increased oxidative stress by the enzyme-independent free radical oxidation of arachidonic acid in membrane phospholipids and lipoproteins. The F₂ isoprostanes may also independently participate in oxidative injury. They are characterized by biological activities mediated by the endothelium which antagonize nitric oxide. Such functions include platelet activation, increased platelet adhesiveness, and platelet aggregation, as well as constriction of the renal and pulmonary vasculature. The F₂ isoprostanes are generally regarded as an accurate means of clinically quantifying lipid peroxidation and oxidant stress.

Isoprostane levels in plasma and in some cases in urine are increased in pathogenic conditions caused by oxidant stress and are considered a reliable marker for oxidant stress (Souvignet et al., Fundam Clin Pharmacol 14:1 (2000); Mori et al., Anal Biochem 268:117 (1999)). Antioxidants such as alpha tocopherol have been shown to reduce such isoprostane levels in biological fluids (Souvignet et al., Fundam Clin Pharmacol 14:1 (2000)). Urinary isoprostane levels are significantly higher in smokers than in non-smokers, showing that isoprostane levels in specimens from a patient correlate with oxidant stress (Obata et al., J Chromatogr B Biomed Sci Appl 746:11 (2000)). Women with preeclamptic pregnancy show elevated isoprostane levels in plasma but not in urine (McKinney et al., Am J Obstet Gynecol 183:874 (2000)). Isoprostane levels in plasma of diabetic men was about five-fold higher than in controls, and the isoprostane levels in the diabetics fell by 50% in response to treatment with raxofelast (600 mg twice daily for seven days; Chowienczyk et al., Diabetologia 43:974 (2000)). Raxofelast is a synthetic, water soluble antioxidant which is an analogue of alpha tocopherol. Raxofelast, which is 2-(2,3-dihydro-5-acetoxy-4,6,7-trimethylbenzofuranyl) acetic acid (IRFI 016), is converted in the body to an active metabolite, 2-(2,3-dihydro-5-hydroxy-4,6,7-trimethylbenzofuranyl) acetic acid (IRFI 005). Quantitation of nitric oxide- and oxidant stress-related products

The “level” of nitric oxide-related product or oxidant stress-related product usually refers to the concentration (in moles per liter, micromoles per liter, or other suitable units) of the respective product in the specimen, or in the fluid portion of the specimen. However, other units of measure can also be used to express the level of the products. For example, an absolute amount (in micrograms, milligrams, nanomoles, micromoles, moles, or other suitable units) can be used, particularly if the amount refers back to a constant amount, mass, or volume of patient specimen (e.g., grams, kilograms, milliliters, liters, or other suitable units). A number of commercially available kits (Cayman Chemical, Ann Arbor, Mich.) can be used.

Methods of detecting oxidant stress-related products are likewise known in the art. For example, ⁸-epi-PGF₂ₐₗₚₕₐ, one of the most abundant isoprostanes, can be quantified in plasma and urine using silica and reverse phase HPLC followed by gas chromatography-mass spectrometry (Mori et al., Anal Biochem 268:117 (1999)). Alternatively, an enzyme immunoassay kit for determination of 8-isoprostane is commercially available (Cayman Chemical cat. no. 516351). Plasma specimens from healthy human patients typically contain about 40-100 pg/ml of 8-isoprostane, while urine specimens from healthy humans contain about 10-50 ng of 8-isoprostane per mmol of creatinine (Wang et al., J Pharmacol Exp Ther 275:94 (1995); Reilly et al., Fibrinolysis & Proteolysis 11:81 (1997)). Several assays exist for malondialdehyde (MDA) in plasma, urine, and other specimens. Such assays include specific reagents for UV detection by HPLC (Steghens et al., Free Radic Biol Med 31:242 (2001) and Pilz Chromatogr B Biomed Sci appl 742:315 (2000)) and capillary electrophoresis (Korizis et al., Biomed Chromatogr 15:287 (2001)). A variety of lipid peroxidation products including MDA can be quantified using the thiobarbituric acid reaction (Fukanaga et al., Biomed Chromatogr 12:300 (1998)). Another by product of lipid peroxidation that can be detected in specimens is 4-hydroxy-2-nonenal (HNE). HNE can be detected using antibodies (Tanaka et al., Arch Dermatol Res 293:363 (2001)) or derivitization with a fluorescent reagent followed by micellar electrokinetic chromatographic separation and laser-induced fluorescence detection (Claeson et al., J Chromatogr B Biomed Sci Appl 763:133 (2001)). Oxidized LDL can be quantified by immunohistochemical techniques (Javed et al., Exp Mol Pathol 65:121 (1999)) and by reaction with thiobarbituric acid (Tanaka et al., Biol Pharm Bull 16:538 (1993)). Advanced glycation end products (AGEs), also known as advanced Maillard products, are irreversibly glycated proteins that catalyze the formation of free radicals. Their presence is indicative of oxidant stress in old age, atherosclerosis, diabetes, and other conditions related to endothelial dysfunction. AGEs can be detected as outlined by Yim et al., Ann N Y Acad Sci 928:48 (2001) and references described therein.

Treatment to Increase Nitric Oxide Production or the Nitric Oxide Bioactivity Index Value

Any therapy designed to increase nitric oxide production or reduce oxidant stress can be used to treat patients identified as not responding to hyperbaric oxygen therapy treatment. Such therapies include, but are not limited to administering to the subject L-arginine, a nitric oxide-releasing agent, an antioxidant, a gene transfer vector comprising a polynucleotide encoding an iNOS enzyme, a drug that lowers plasma cholesterol or triglycerides, and a diet or instructing the patient to adhere to a diet. Following treatment, nitrate and nitrite levels or NOBI can be determined for the patient. If nitrate and nitrite levels in a sample from a patient are above a threshold value then the patient will respond to hyperbaric oxygen therapy treatment. If the nitrate and nitrite levels in a sample from the patient are approximately at or below the threshold value then the patient may not respond to hyperbaric oxygen therapy treatment and additional treatment to increase NOBI can be used, or the treatment time can be increased. If the NOBI value (defined as a ratio of a nitric oxide-related product to an oxidant stress related product) is above a threshold value then the patient will respond to hyperbaric oxygen therapy treatment and can be treated. If the NOBI value (defined as a ratio of a nitric oxide-related product to an oxidant stress related product) is approximately at or below the threshold value then the patient may not respond to hyperbaric oxygen therapy treatment and additional treatment to increase NOBI can be used, or the treatment time can be increased.

In some circumstances, two-dimensional analysis of NOBI allows a clinician to implement therapies to correct individual underlying factors (e.g., endothelial dysfunction, see U.S. utility application Ser. No. 10/290,476 (attorney docket number 4629.00015) filed Nov. 8, 2002, and provisional applications Serial No. 60/333,474 filed Nov. 28, 2001, Serial No. 60/349,348 filed Jan. 22, 2002, and Serial No. 60/370,246 filed Apr. 8, 2002) that contribute to a patient's non-response to hyperbaric oxygen therapy treatment. For two-dimensional analysis the level of a nitric oxide-related product and the level of an oxidant stress-related product are plotted on separate axes, i.e., in two dimensions, and compared to the normal range of NOBI values on the same graph. Normal NOBI values ordinarily will be distributed as a band (ideally a line) whose slope corresponds to the average normal NOBI. Two dimensional analysis can reveal whether the a patient's non-response to hyperbaric oxygen therapy treatment is dominated by either a deficit in nitric oxide synthesis or an excess of oxidant stress. If a patient or group average NOBI is displaced from the normal NOBI curve more along the axis representing the nitric oxide-related product, then the predominant defect is more likely to be one of inadequate nitric oxide synthesis. If, on the other hand, the patient or group average NOBI is displaced from the normal NOBI curve more along the axis representing an oxidant stress-related product, then the predominant defect is more likely to be one of excess reactive oxygen species, excess free radicals, or insufficient antioxidant defenses. Utilizing two-dimensional analysis a clinician can tailor treatment to increase the NOBI value of a patient. For example, a patient with a high oxidant stress level might respond better to antioxidant therapy than a patient with a low rate of nitric oxide synthesis. Conversely, a patient with a low nitric oxide synthetic rate might respond better to L-arginine therapy than a patient with high oxidant stress.

Kits

Another embodiment is a kit for determining whether a patient will respond to hyperbaric oxygen therapy treatment. The kit comprises (1) one or more reagents for determining the level of nitric oxide production, (2) one or more reagents for determining the level of a nitric oxide-related product, or (3) one or more reagents for determining the level of a nitric oxide-related product and one or more reagents for determining the level of an oxidant stress related product in a specimen from a patient. The reagent or reagents can be those required by any method known in the art for determination of (1) the level of nitric oxide production, (2) the level of a nitric oxide-related product, or (3) the level of a nitric oxide-related product and the level of an oxidant stress-related product in a specimen. The kit can also include a set of instructions for using the reagents to carry out the method of determining whether a patient will respond to hyperbaric oxygen therapy treatment, as described above. The instruction set provides information in any suitable format (e.g., printed on paper or in electronic format on a diskette, CD-ROM, or by reference to a web site or printed publication) to allow the user to collect a suitable specimen, process the specimen, use the reagent or reagents to determine (1) the level of nitric oxide production, (2) the level of a nitric oxide-related product, or (3) the level of a nitric oxide-related product and the level of an oxidant stress-related product in a specimen, and interpret the results obtained, i.e., to compare the results to a threshold which allows the user to determine whether the patient will respond to hyperbaric oxygen therapy treatment. In a preferred embodiment, the nitric oxide-related product whose level is determined by using the kit is plasma nitrate and the oxidant stress-related product whose level is determined by using the kit is plasma F₂ isoprostane.

All patents, patent applications, and references cited in this disclosure are expressly incorporated herein by reference in their entireties. The above disclosure generally describes the present invention. A more complete understanding can be obtained by reference to the following specific examples, which are provided for purposes of illustration only and are not intended to limit the scope of the invention.

### EXAMPLE 1

Effects of Routine Clinical Hyperbaric Oxygen Therapy on Endogenous Nitric Oxide Production

The following documents the treatment and outcome of a diabetic ulcer patient evaluated at the HCA Retreat Hospital Wound Healing Center (WHC) who received hyperbaric oxygen therapy (HBOT) for a chronic, non-healing lower extremity wound. The effects of routine HBOT on endogenous nitric oxide (NO) production through measurements of the stable NO metabolite nitrate (NOx) obtained from the patient's plasma, urine and wound fluid prior to, during and following HBOT are also documented. These determinations have been performed to assist in the formulation of clinical opinions and questions regarding the relationship between endogenous NO production, wound healing and HBOT.

Case History

The patient was a 66-year-old male with a history of Type II diabetes mellitus who presented with a non-healing, traumatic ulceration of the left anterior lower leg that had not healed for the past two months. He had a history of a similar lesion of the same leg about 18 months earlier that healed without complications.

Past Medical History

In addition to the Type II diabetes mellitus the patient's past medical history was significant for diabetic neuropathy, hypertension, coronary artery disease, angina, s/p coronary artery stent placement, spinal stenosis and secondary lumbar laminectomy, hypercholesterolemia and non-claudicating peripheral vascular disease (PVD) of both lower extremities (Doppler evaluation). His diabetes was well controlled with an Hgb AIC of 6.5%. Renal function and urine microalbumin were within normal limits. Complete metabolic profiles obtained during treatment were within normal limits with the exception of elevated glucose levels (114-160 mg/dl). Medications included Glucophage® and Micronase®, Accupril®, Pravachol®, ASA, calcium supplements, multivitamins and fish oil. Negative history of medication allergies.

Physical Examination

Examination of the left lower leg confirmed the presence of a chronic, inflamed ulceration of the anterior lower left leg. The wound was full-thickness, about 1 cm in diameter and located about 6-7 cm above the ankle. The wound was Stage 11/111 with a yellow-tan necrotic eschar at the base with mild marginal erythema, +2 periwound edema but no crepitance, cellulitis or lymphangitis. A moderate amount of serous drainage was observed within the base of the wound. Distal to the wound, the left foot displayed trace to +1 edema but no erythema, ecchymosis or dorsal or plantar ulcerations. The patient presented with neuropathic findings of the left foot from the heel distally. No palpable pulses were noted at the ankle. No Grade II or Grade III pulses were obtained below the popliteals on the left or right lower extremities, respectively. Doppler studies also confirmed peripheral vascular disease with attenuated waveforms from the calf distally on the right and from the ankle down on the left. ABI was greater than 1.0 on both lower extremities. Toe pressure on the right was 40 mmHg and on the left was 60 mmHg. The initial impression was that of an infected, ischemic ulceration of the left lower leg in a non-insulin dependent diabetic patient with moderate, non-claudicating peripheral vascular disease. Wound (swab) culture results were positive for S. Aureus (not MRSA) and P. Aeruginosa.

Clinical Course

The patient's wound responded promptly to topical therapy, hydrotherapy, debridement and antibiotics and showed improvement in the wound base color and with increased granulation tissue deposition during the first few weeks of treatment. However, at this time the patient presented with the acute onset of painful swelling of the left calf muscles and significantly increased edema of the distal left lower leg and foot with ecchymosis of the periwound area. Venous Doppler's confirmed an intramuscular hematoma of the gastrocnemius muscle with possible compartment syndrome of the posterior compartment with no DVT. The patient was admitted to HCA Retreat Hospital and received surgical evacuation of the hematoma and fasciotomy of the posterior calf compartment with closed post-operative drainage. At the time of surgery the patient was observed with a second smaller ulcer (<1.0 cm) a few cm proximal to the original wound. During surgery both ulcers were sharply debrided. After surgical hematoma evacuation and ulcer debridement transcutaneous oxygen measurements (TCOMS) of the left lower leg in the proximal and distal periwound area confirmed local wound ischemia with room air readings of 28 and 15 mmHg P⁰2, respectively.

Because of the increased number and size of the left lower extremity wounds, a lack of clinical progress and the recent history of a left lower leg posterior compartment syndrome adjunctive HBOT was recommended on the clinical basis of secondary acute peripheral arterial insufficiency. The patient had no contraindications for HBOT and was prepared for outpatient treatment in the WHC HBO Department. The patient received informed consent for HBOT and agreed to the sampling of urine, blood and wound fluid specimens immediately prior to, during and for one month following HBOT. The clinical protocol for this study was previously evaluated and approved by the Institutional Review Board of HCA Retreat Hospital.

HBOT was scheduled as a daily outpatient therapy at 2.0ATA pressure for 90-minutes. Fasting plasma and urine samples were obtained at the following times: immediately prior to the beginning of HBOT (pre-treatment specimens), immediately before and after HBO treatments number 10 and 20, and at one week and one month following the completion of the 20 scheduled HBO treatments. By the time HBOT was started the wounds measured 5.6 and 1.5 square centimeters. Wound fluid was obtained by use of a nitrate-free collection system used with the larger wound for 24 hours prior to scheduled wound fluid retrieval. Wound care during HBOT consisted only of normal saline cleansing, preservative-free hydrogel and a moist dressing technique. The patient completed HBOT and specimen collections with no complications or adverse events and experienced complete healing of the two chronic ulcers of the left leg in less than 8 weeks following the completion of therapy.

Results of Nitrate Assays and Wound Closure

Urine Nitrate Excretion Determinations Following HBO Therapy

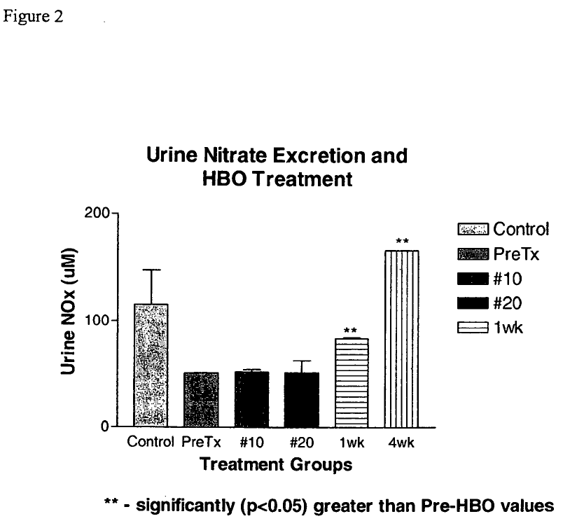

Urine nitrate excretion determinations performed prior to HBO treatment (PreTx) and during HBO treatments 10 and 20 (#10 and #20, respectively) and at one week (1 wk) and four weeks (4 wk) following conclusion of HBO treatment are presented in FIG. 2. Values represent micromoles per liter of nitrate. The far left column of values on the graph (Control) represents a summary of control values of urine nitrate excretion from eight healthy, non-diabetic adults obtained from an unrelated study performed in our center. Prior to HBO therapy our study patient is observed with a fasting urine nitrate (PreTx=50.89[±0.22]) level that is clearly well below control values (Control =115.6 [±32.23]). After beginning HBO therapy urine nitrate excretion level is essentially unchanged (#10 =51.99[±2.31] and #20 =51.27[±11.47]) until one week following the completion of therapy when it is significantly greater than pre-treatment values (1 wk=83.78[±1.0]). By four weeks after the completion of HBO therapy urine nitrate excretion has further increased (4 wk=166[±1.0]) and is now higher than those of the non-diabetic control population.

Plasma Nitrate Determinations Following HBO Therapy

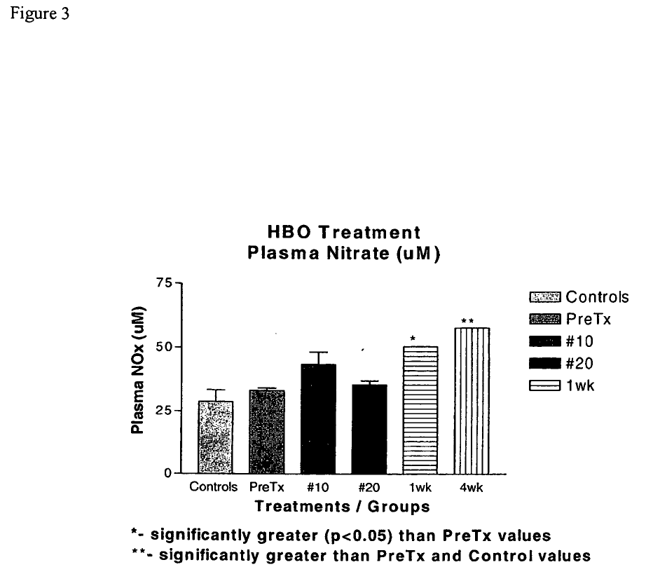

Following HBO therapy, gradually increasing plasma nitrate values are also observed (FIG. 3) in a fashion similar to the urine nitrate excretion data. In this case we find that the control (healthy, non-diabetic) plasma nitrate value (28.78[±4.66]) is essentially comparable to the pretreatment plasma nitrate value of the study subject (PreTx=33.20[±1.0]). Following the initiation of HBO treatments plasma nitrate values demonstrate slight variability (#10=43.55[±4.85] and #20 =35.50[+1.6]) but are not significantly different from the pretreatment value. However, at one week following the completion of HBO treatment, plasma nitrate is elevated (1 wk=50.54[±0.11]) and is significantly greater than pretreatment values. By four weeks after HBO treatment completion the plasma nitrate value has increased further and is now significantly greater than both pretreatment and control plasma nitrate values (4 wk=57.85[±0.15]).

Wound Fluid Determinations Following HBO Therapy

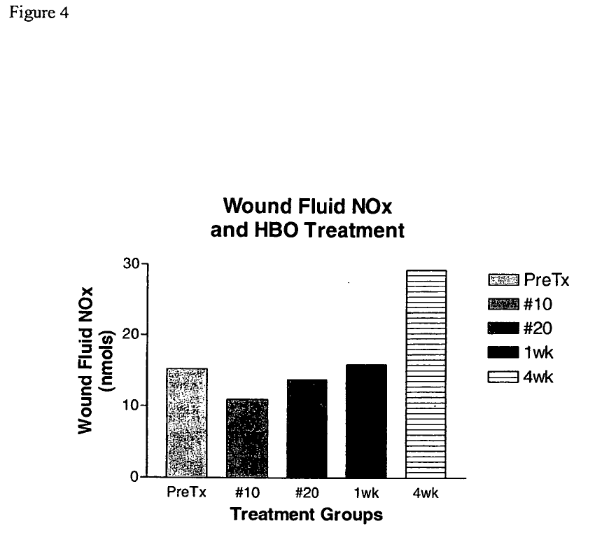

Unlike plasma and urine nitrate determinations, wound fluid values are expressed in nanomolar amounts (nanomoles per liter). FIG. 4 shows wound fluid nitrate levels before, during and after HBO treatment. Wound fluid is collected for 24 hours prior to retrieval for processing. Prior to HBO treatment wound fluid nitrate levels are 15.21 nmols. During HBO treatment there is a modest reduction in wound fluid levels (#10=10.93 and #20=13.71). However, as with plasma and urine nitrate values, the post HBO treatment measurements document elevations of wound fluid to near pretreatment levels at one week after HBO treatment completion (1 wk =15.80) and an apparent significant elevation in wound fluid nitrate by four weeks after the completion of HBO therapy (4 wk=29.30).

Wound Closure and Plasma NOx Following HBO Treatment

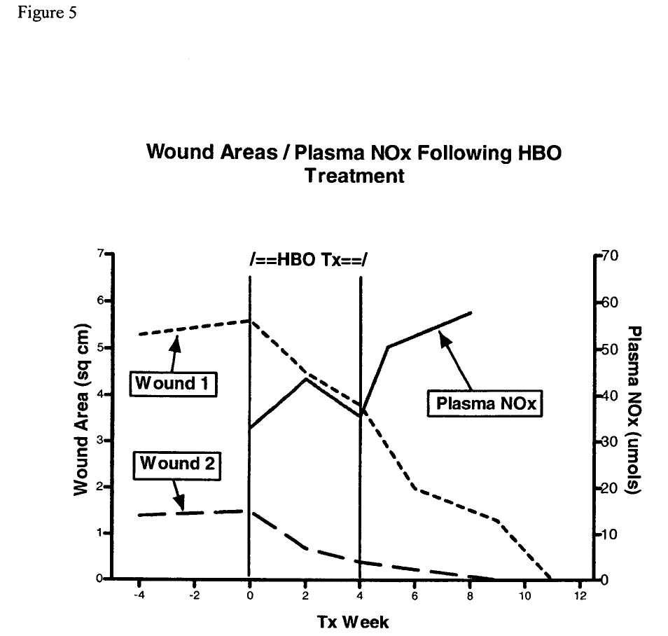

At the beginning of HBO therapy the left lower leg wound sizes were estimated at 5.6 cm (Wound 1) and 1.5 cm² (Wound 2). The wounds were clean, full-thickness with scant granulation tissue and without exposed bone, tendon, or neurovascular structures. Pre-HBOT measurements of the two wounds from four weeks prior to therapy (Tx Week=(−)4) to the beginning of HBOT (Tx Week=0) demonstrated no improvement in wound size. Immediately following the initiation of HBOT measurable reductions in the areas of both wounds were documented (FIG. 5). By the completion of half of the 20 scheduled HBO treatments (Tx Week=2) the area of Wound 1 was reduced by 20% to 4.5 cm² and Wound 2 was reduced by 53% to 0.7 cm². At the completion of schedule HBOT (Tx Week=4) Wound 1 was reduced by 32% to 3.8 cm² and Wound 2 was reduced by 73% to 0.4 cm². Wound 1 area continues to decrease after HBOT with its area reduced to 36% (2.0 cm 2) and 23% (1.3 cm²) at 2 and 6 weeks after HBOT, respectively. By 8 weeks following HBOT Wound 1 is completely closed. After HBOT Wound 2 continues to close as well and is decreased to 13% (0.2 cm²) at 2 weeks after therapy and is completely closed at 6 weeks.

Plasma NOₓ, which is first measured just prior to HBOT (PreTx=33.20[±1.0]), appears to demonstrate an inverse relationship to wound area reduction during and following HBOT. As outlined in the earlier section on Plasma NOₓ, we have an early elevation in plasma NOₓ at Tx Week 2 (43.55[±4.85]) followed by a slight reduction immediately prior to the last HBO treatment at Tx Week 4 (35.50[±1.6]). After the completion of HBOT the plasma NOₓ values continue to increase (Tx Week 5=50.54 [±0.1 1] and Tx Week 8 =57.85 [±0.15]) while the areas of Wounds 1 and 2 maintain their rate of reduction to complete closure of both wounds by Tx Week 12.

### EXAMPLE 2

Hyperbaric Oxygen Therapy Treatment and Plasma Nitrate

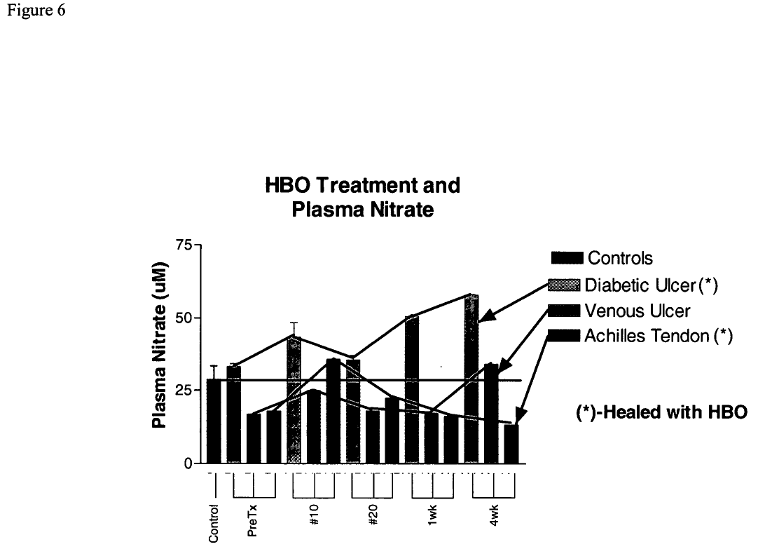

Plasma nitrate levels were determined for three patients and a control. The patients represent the diabetic ulcer patient described in Example 1, a venous ulcer patient, and a healthy patient with a non-healing Achilles tendon repair site. Plasma nitrate levels were determined as described in Example 1. Levels were determined pretreatment, at 10 and 20 hyperbaric oxygen therapy treatments, and at 1 and 4 weeks post-treatment. See FIG. 6.

The pretreatment plasma nitrate level of the diabetic ulcer patient was above the threshold level and this patient was predicted to respond favorably to hyperbaric oxygen therapy treatment. This patient's plasma nitrate levels increased during the first 10 hyperbaric oxygen therapy treatments. As was shown in Example 1, this patient did respond favorably and the wounds healed.

The healthy patient with a non-healing Achilles tendon repair site (the Achilles patient) and the venous ulcer patient had pretreatment plasma nitrate levels below the threshold and thus were not predicted to heal. However, hyperbaric oxygen therapy treatment was administered. The Achilles patient showed an early indication of a favorable response to hyperbaric oxygen therapy treatment as evidenced by the increase in plasma nitrate level of greater than 50% above pretreatment plasma nitrate level. Thus this patient was predicted to respond favorably to the treatment. The Achilles patient responded favorably and the tendon was repaired.

The venous ulcer patient did not show any early indications. The venous ulcer patient's plasma nitrate level was not greater than 50% above the pretreatment plasma nitrate level and thus this patient was predicted to not respond favorably to the treatment. The venous ulcer patient did not respond favorably and no wounds were healed.

1. A method for determining whether a patient will respond favorably to hyperbaric oxygen therapy treatment, the method comprising the steps of:
a. comparing nitric oxide production level in a specimen from a patient with a threshold value; and
b. determining if the patient will respond favorably to hyperbaric oxygen therapy treatment,
wherein if the level of nitric oxide production in specimen from the patient is above the threshold value the patient will respond favorably to hyperbaric oxygen therapy treatment, and if the level of nitric oxide production in the specimen from the patient is approximately at or below the threshold value then the patient may not respond favorably to hyperbaric oxygen therapy treatment.

2. The method of claim 1, further comprising the step of: collecting the specimen from the patient.

3. The method of claim 1 wherein the specimen is urine.

4. The method of claim 1 wherein the specimen is blood.

5. The method of claim 1 wherein the specimen is wound fluid.

6. The method of claim 1 further comprising the step of treating the patient with hyperbaric oxygen.

7. The method of claim 6 wherein the step of treating the patient comprises treating the patient with multiple rounds of hyperbaric oxygen in a hyperbaric oxygen chamber.

8. The method of claim 6 wherein the level of nitric oxide production increases.

9. The method of claim 8 wherein the patient responds favorably to hyperbaric oxygen therapy treatment.

10. The method of claim 1 wherein the level of nitric oxide production is approximately at or below the threshold value.

11. The method of claim 10 further comprising the step of treating the patient with hyperbaric oxygen.

12. The method of claim 11 wherein the level of nitric oxide production increases 50% or more above pretreatment level.

13. A method for determining whether a patient will respond favorably to hyperbaric oxygen therapy treatment, the method comprising the steps of:
a. comparing a nitric oxide-related product level in a specimen from a patient with a threshold value; and
b. determining if the patient will respond favorably to hyperbaric oxygen therapy treatment,
wherein if the level of nitric oxide-related product in specimen from the patient is above the threshold value the patient will respond favorably to hyperbaric oxygen therapy treatment, and if the level of nitric oxide-related product in the specimen from the patient is approximately at or below the threshold value then the patient may not respond favorably to hyperbaric oxygen therapy treatment.

14. The method of claim 13 wherein the nitric oxide-relate product is nitrate.

15. The method of claim 13 wherein the nitric oxide-related product is nitrite.

16. The method of claim 13, further comprising the step of: collecting the specimen from the patient.

17. The method of claim 13 wherein the specimen is urine.

18. The method of claim 13 wherein the specimen is blood.

19. The method of claim 13 wherein the specimen is wound fluid.

20. The method of claim 13 further comprising the step of treating the patient with hyperbaric oxygen therapy.

21. The method of claim 20 wherein the step of treating the patient comprises treating the patient with multiple rounds of hyperbaric oxygen therapy in a hyperbaric chamber.

22. The method of claim 21 wherein the level of the nitric oxide-related product increases.

23. The method of claim 13 wherein the level of the nitric oxide-related product is approximately at or below the threshold value.

24. The method of claim 23 further comprising the step of treating the patient with hyperbaric oxygen.

25. The method of claim 24 wherein the level of the nitric oxide-related product increases 50% or more above pretreatment levels.

26. A method for determining whether a patient will respond favorably to hyperbaric oxygen therapy treatment, the method comprising the steps of:
a. comparing a nitric oxide bioavailability index value in a specimen from a patient with a threshold value; and
b. determining if the patient will respond favorably to hyperbaric oxygen therapy treatment,
wherein the nitric oxide bioactivity index is defined as the level of a nitric oxide-related product divided by the level of an oxidant stress related product in the specimen,
wherein if the value of the nitric oxide bioactivity index in specimen from the patient is above the threshold value the patient will respond favorably to hyperbaric oxygen therapy treatment, and if the value of the nitric oxide bioavailability index in the specimen from the patient is approximately at or below the threshold value then the patient may not respond favorably to hyperbaric oxygen therapy treatment.

27. A method for determining whether a patient will respond favorably to hyperbaric oxygen therapy treatment, the method comprising the steps of:
a. comparing a nitric oxide bioavailability index value in a specimen from a patient with a threshold value; and
b. determining if the patient will respond favorably to hyperbaric oxygen therapy treatment,
wherein the nitric oxide bioactivity index is defined as the level of an oxidant stress related product divided by the level of a nitric oxide-related product in the specimen,
wherein if the value of the nitric oxide bioactivity index in specimen from the patient is below the threshold value the patient will respond favorably to hyperbaric oxygen therapy treatment, and if the value of the nitric oxide bioavailability index in the specimen from the patient is approximately at or above the threshold value then the patient may not respond favorably to hyperbaric oxygen therapy treatment.

28. The method of claim 26 or 27, further comprising the step of determining the level of a nitric oxide-related product in the specimen.

29. The method of claim 26 or 27, further comprising the step of determining the level of an oxidant stress related product in the specimen.

30. The method of claim 26 or 27, further comprising the step of: collecting the specimen.

31. The method of claim 26 or 27 wherein the specimen is urine.

32. The method of claim 26 or 27 wherein the specimen is blood.

33. The method of claim 26 or 27 wherein the specimen is wound fluid.

34. A kit for determining whether a patient will respond favorably to hyperbaric oxygen therapy treatment, the kit comprises either
(1) one or more reagents for determining the level nitric oxide production in a specimen from the patient,
(2) one or more reagents for determining the level of a nitric-oxide-related product in the specimen from the patient, or
(3) one or more reagents for determining the level of an oxidant stress related product in the specimen and one or more reagents for determining the level of a nitric-oxide-related product in the specimen from the patient.
